(19) United States
(12) Patent Application Publication
(10) Pub. No.: US 2025/0389614 A1
(43) Pub. Date: Dec. 25, 2025

(54) DETECTION CIRCUIT AND IMAGE GENERATION DEVICE

(71) Applicant: Panasonic Intellectual Property Management Co., Ltd., Osaka (JP)

(72) Inventors: SHIGETAKA KASUGA, Osaka (JP); KENSUKE MIHARA, Osaka (JP); YUSUKE SAKATA, Osaka (JP); DAISUKE WAKUDA, Kyoto (JP); JUN TAKIGAWA, Osaka (JP)

(21) Appl. No.: 19/305,866

(22) Filed: Aug. 21, 2025

Related U.S. Application Data
(63) Continuation of application No. PCT/JP2024/006389, filed on Feb. 21, 2024.

(30) Foreign Application Priority Data
Mar. 14, 2023 (JP) 2023-039642

(51) Int. Cl. G01M 11/00; G02B 26/08; G02B 26/10

(52) U.S. Cl. CPC G01M 11/005; G02B 26/0858; G02B 26/101

(57) ABSTRACT

Provided are a detection circuit and an image generation device capable of accurately generating a detection signal corresponding to a change in a scanning speed. Mirror detection circuit (detection circuit) inputs a voltage generated in a monitoring piezoelectric element for monitoring an operation state of a second scanning part (light deflecting element) to a gate of field effect transistor constituting a source follower circuit, and generates a detection signal corresponding to expansion or contraction of the piezoelectric element from a source voltage of field effect transistor.

### BACKGROUND

### 1. Technical Field

The present disclosure relates to a detection circuit for detecting a driving state of a light deflecting element and an image generation device including the detection circuit.

### 2. Description of the Related Art

In related art, an image generation device that generates an image by scanning light modulated by a video signal has been known. In this device, for example, while light is scanned in a horizontal direction in a first cycle, light is scanned in a vertical direction in a second cycle longer than the first cycle, and an image for one frame is generated. The first cycle corresponds to a cycle of one line of the video signal, and the second cycle corresponds to a frame cycle of the video signal.

This type of image generation device is described in, for example, PTL 1 below. In this device, light is scanned in a horizontal direction and a vertical direction by a light deflecting element by using a piezoelectric actuator as a driving source. In this case, a predetermined image can be appropriately displayed by detecting a driving state of each light deflecting element. For example, a monitoring piezoelectric element is arranged in the light deflecting element in order to detect the driving state.

As a detection circuit using the piezoelectric element, for example, a detection circuit described in PTL 2 below has been known. In general, it has been known that the magnitude of a current generated by the piezoelectric element is proportional to a speed at which the piezoelectric element expands or contracts. That is, the generated current of the piezoelectric element is obtained by differentiating an expansion or contraction state of the piezoelectric element. Accordingly, in the detection circuit, a detection signal indicating the expansion or contraction state of the piezoelectric element is generated by converting the generated current of the piezoelectric element into a voltage by an I/V converter (current-voltage converter) and integrating the converted voltage by an integrator.

### CITATION LIST

### Patent Literature

PTL 1: Unexamined Japanese Patent Publication No. 2018-155989
PTL 2: Unexamined Japanese Patent Publication No. 2008-033567

### SUMMARY

However, since the integrator is used in the detection circuit described in PTL 2, it is difficult to generate a high-quality detection signal in a case where a scanning speed of the light polarizing element changes sharply. That is, the integrator cannot follow the change in the scanning speed, and a waveform of the detection signal at this change point hardly becomes a sharp-edge waveform corresponding to the speed change.

In view of such a problem, an object of the present disclosure is to provide a detection circuit and an image generation device capable of accurately generating a detection signal corresponding to a change in a scanning speed.

A first aspect of the present disclosure relates to a detection circuit for detecting an operation state of a light deflecting element. The detection circuit according to this aspect inputs a voltage generated in a monitoring piezoelectric element for monitoring the operation state to a gate of a field effect transistor constituting a source follower circuit, and generates a detection signal corresponding to expansion or contraction of the piezoelectric element from a source voltage of the field effect transistor.

In accordance with the detection circuit according to the present aspect, the voltage of the monitoring piezoelectric element is input to the gate of the field effect transistor constituting the source follower circuit. The source follower circuit has a wide input range (frequency band) and high followability to the input voltage. Thus, even in a case where the scanning speed of the light polarizing element changes steeply, it is possible to generate a detection signal that accurately follows the change in the scanning speed. Accordingly, the detection signal corresponding to the change in the scanning speed can be accurately generated.

A second aspect of the present disclosure relates to an image generation device. The image generation device according to this aspect includes the detection circuit according to the first aspect, the light deflecting element in which the monitoring piezoelectric element is arranged, and a controller that controls an operation of the light deflecting element based on the detection signal from the detection circuit.

In accordance with the image generation device according to the present aspect, since the detection circuit according to the first aspect is provided, the operation state of the light deflecting element, that is, the scanning position of the light can be accurately detected. Accordingly, the scanning position of the light can be smoothly and accurately controlled by the detection signal from the detection circuit.

As described above, in accordance with the detection circuit and the image generation device of the present disclosure, it is possible to provide the detection circuit and the image generation device capable of accurately generating the detection signal corresponding to the change in the scanning speed.

Effects or meanings of the present disclosure will be further clarified in the following description of exemplary embodiments. However, the exemplary embodiment described below is merely an example of implementing the present disclosure, and the present disclosure is not at all limited to the examples described in the following exemplary embodiment.

### BRIEF DESCRIPTION OF THE DRAWINGS

FIG. 1 is a perspective view schematically illustrating a configuration of augmented reality glasses (AR glasses) according to an exemplary embodiment;

FIG. 2 is a diagram schematically illustrating a configuration of a projection part according to the exemplary embodiment;

FIG. 3 is a block diagram illustrating a configuration of a circuit portion of an image generation device according to the exemplary embodiment;

FIG. 4 is a plan view illustrating a configuration of a second scanning part according to the exemplary embodiment;

FIG. 5 is a circuit diagram illustrating a configuration of a mirror position detection circuit according to a comparative example;

FIG. 6 is a graph representing simulation results of a detection signal (integral output) output from an integrator according to the comparative example;

FIG. 7 is a circuit diagram illustrating a configuration of a mirror detection circuit according to Example 1;

FIG. 8 is a graph representing simulation results of signals (voltages) generated at positions (A) to (D) in FIG. 7 according to Example 1;

FIG. 9A is a graph in which a monitor voltage and an SF output (source follower output) are extracted in a predetermined time range from the simulation results of FIG. 8 according to Example 1;

FIG. 9B is a graph in which a monitor voltage and a clamp output are extracted in a predetermined time range from the simulation results of FIG. 8 according to Example 1;

FIG. 10 is a graph in which a monitor voltage and a detection signal are extracted in a predetermined time range from the simulation results of FIG. 8 according to Example 1;

FIG. 11 is a circuit diagram illustrating a configuration of mirror detection circuit 45 according to Example 2;

FIG. 12 is a diagram illustrating simulation results related to an output of a high-pass filter according to Example 2;

FIG. 13A is a graph representing simulation results of a monitor voltage and an SF output according to Example 2;

FIG. 13B is a graph representing simulation results of a monitor voltage and a clamp output according to Example 2;

FIG. 14 is a graph representing simulation results of a monitor voltage and a detection signal according to Example 2;

FIG. 15 is a diagram illustrating simulation results of a voltage output from a field effect transistor (source follower circuit) in a case where two types of monitor voltages having different DC components are input to a gate of the field effect transistor in the configuration of Example 1;

FIG. 16 is a graph representing simulation results of voltages generated at positions in FIG. 11 in a case where two types of monitor voltages illustrated in FIG. 15 are output from a piezoelectric element according to Example 2;

FIG. 17A is a diagram illustrating a gain characteristic graph (Bode diagram) of a mirror detection circuit according to Example 2; and

FIG. 17B is a graph (Bode diagram) illustrating phase characteristics of the mirror detection circuit according to Example 2.

### DETAILED DESCRIPTIONS

Hereinafter, an exemplary embodiment of the present disclosure will be described with reference to the drawings.

In the following exemplary embodiment, an example in which a technology of the present disclosure is applied to an image generation device of augmented reality glasses (AR glasses) is illustrated. However, the following exemplary embodiment is an exemplary embodiment of the present disclosure, and the technology of the present disclosure is not limited to the following exemplary embodiment at all. For example, the present disclosure can be applied not only to the image generation device of the AR glasses but also to an image generation device such as augmented reality (AR) goggles, virtual reality glasses (VR glasses), virtual reality (VR) goggles, or an in-vehicle head-up display.

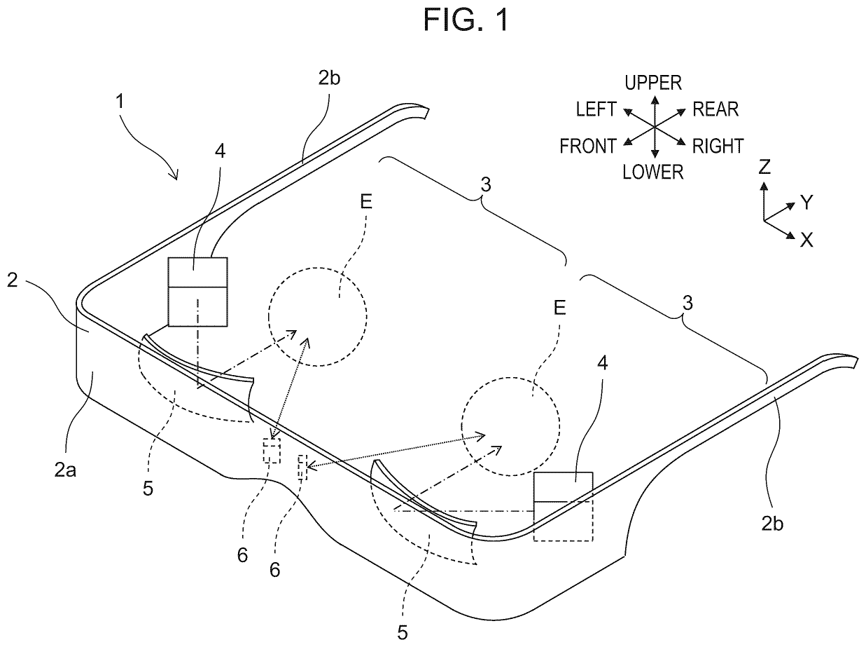

FIG. 1 is a perspective view schematically illustrating a configuration of AR glasses 1.

In FIG. 1, X-, Y-, and Z-axes orthogonal to each other are added together with front, rear, left, right, upper, and lower directions of AR glasses 1. An X-axis positive direction, a Y-axis positive direction, and a Z-axis positive direction correspond to the right direction, the rear direction, and the upper direction of AR glasses 1, respectively.

AR glasses 1 include frame 2 and a pair of image generation devices 3. Each of the pair of image generation devices 3 is symmetrical with respect to a Y-Z plane passing through a center of AR glasses 1. Image generation device 3 includes projection part 4, half mirror 5, and detection part 6. Similarly to general eyeglasses, AR glasses 1 are worn on the head of a user.

Frame 2 includes front surface portion 2a and a pair of supports 2b. The pair of supports 2b extends rearward from a right end and a left end of front surface portion 2a, respectively. When frame 2 is worn by the user, front surface portion 2a is positioned in front of a pair of eyes E of the user. Front surface portion 2a is made of a transparent material (for example, resin or the like).

Projection part 4 is installed on an inner surface of support 2b. Projection part 4 projects light modulated by a video signal to corresponding half mirror 5.

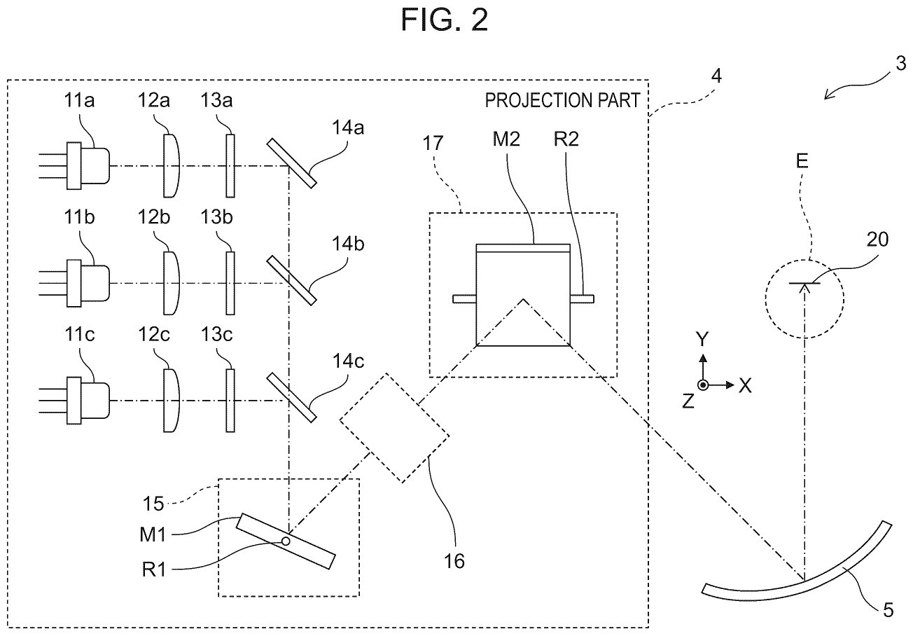

Half mirrors 5 are installed on an inner surface of front surface portion 2a. Half mirror 5 reflects light projected from corresponding projection part 4 to eye E of the user and transmits light traveling in a front-rear direction. The light from projection part 4 reflected by half mirror 5 is applied to the fovea positioned at a center of the retina in eye E. As a result, the user can visually grasp frame image 20 (see FIG. 2) generated by image generation device 3. In addition, since the user can see the front of AR glasses 1 through half mirrors 5, the user can visually grasp a state of the front of AR glasses 1 and frame image 20 generated by image generation device 3 in an overlapping manner.

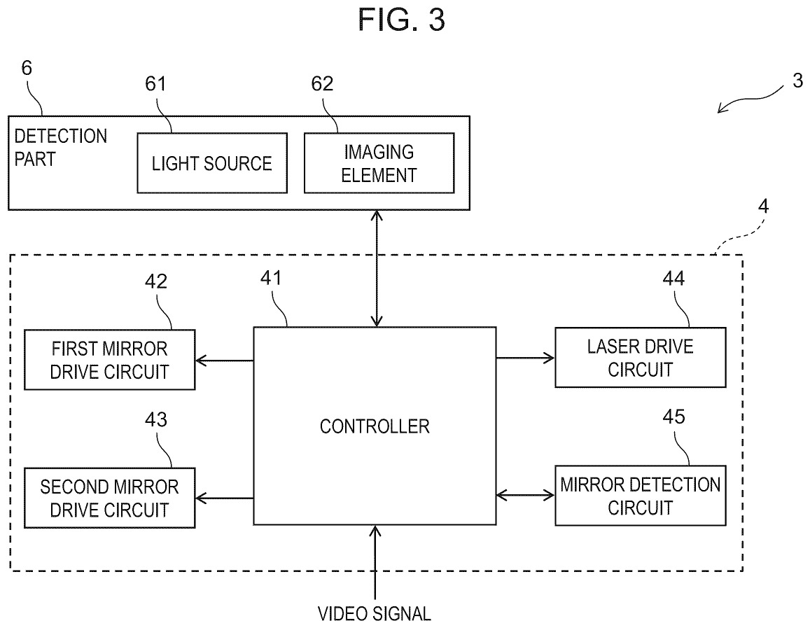

The pair of detection parts 6 is installed on the inner surface of front surface portion 2a and is positioned between the pair of half mirrors 5. Detection part 6 is used to detect a line of sight of the user. The detection of the line of sight of the user will be described later with reference to FIG. 3.

FIG. 2 is a diagram schematically illustrating a configuration of projection part 4.

Projection part 4 includes light sources 11a, 11b, and 11c, collimator lenses 12a, 12b, and 12c, apertures 13a, 13b, and 13c, mirror 14a, dichroic mirrors 14b and 14c, first scanning part 15, relay optical system 16, and second scanning part 17.

Light sources 11a, 11b, and 11c are, for example, semiconductor lasers. Light source 11a emits a laser beam having a red wavelength in a range from 635 nm to 645 nm inclusive, light source 11b emits a laser beam having a green wavelength in a range from 510 nm to 530 nm inclusive, and light source 11c emits a laser beam having a blue wavelength in a range from 440 nm to 460 nm inclusive.

In the present exemplary embodiment, since a color image is generated as frame image 20 to be described later, projection part 4 includes light sources 11a, 11b, and 11c capable of emitting red, green, and blue laser beams, respectively. In a case where a monochrome image is displayed as frame image 20, projection part 4 may include only one light source corresponding to a color of the image. In addition, projection part 4 may include two light sources having different emission wavelengths.

The light rays emitted from light sources 11a, 11b, and 11c are converted into parallel light rays by collimator lenses 12a, 12b, and 12c, respectively. The light rays transmitted through collimator lenses 12a, 12b, and 12c are shaped into substantially circular beams by apertures 13a, 13b, and 13c, respectively.

Mirror 14a substantially totally reflects the red light having passed through aperture 13a. Dichroic mirror 14b reflects the green light having passed through aperture 13b, and transmits the red light reflected by mirror 14a. Dichroic mirror 14c reflects the blue light having passed through aperture 13c, and transmits the red light and the green light having passed through dichroic mirror 14b. Mirror 14a and two dichroic mirrors 14b and 14c are arranged to align optical axes of light rays of colors emitted from light sources 11a, 11b, and 11c.

First scanning part 15 reflects the light having passed through dichroic mirror 14c. First scanning part 15 is, for example, a micro electro-mechanical system (MEMS) mirror. First scanning part 15 is configured to rotate first mirror M1, on which the light having passed through dichroic mirror 14c is incident, around rotation shaft R1 parallel to a Z-axis direction in accordance with a drive signal. First mirror M1 rotates, and thus, a reflection direction of the light changes. As a result, the light reflected by first mirror M1 is scanned in an X-axis direction (horizontal direction) in the retina of eye E.

Relay optical system 16 directs the light reflected by first scanning part 15 toward a center of second mirror M2 of second scanning part 17. That is, the light incident on first scanning part 15 is shaken by first mirror M1 at a predetermined swing angle. Relay optical system 16 directs the light at each swing angle toward the center of second mirror M2. Relay optical system 16 includes a plurality of mirrors, and reflects the light reflected by first scanning part 15 by the plurality of mirrors to direct the light toward second scanning part 17. As a result, a long optical path length can be realized inside relay optical system 16, and a swing angle of light as viewed from second mirror M2 can be suppressed.

Second scanning part 17 reflects the light having passed through relay optical system 16. Second scanning part 17 is a MEMS mirror. Second scanning part 17 rotates second mirror M2 on which the light having passed through relay optical system 16 is incident around rotation shaft R2 parallel to an X-Y plane in accordance with a drive signal. Second mirror M2 rotates, and thus, a reflection direction of the light changes. As a result, in the retina of eye E, the light scanned in the X-axis direction (horizontal direction) by first scanning part 15 is also scanned in the Z-axis direction (vertical direction).

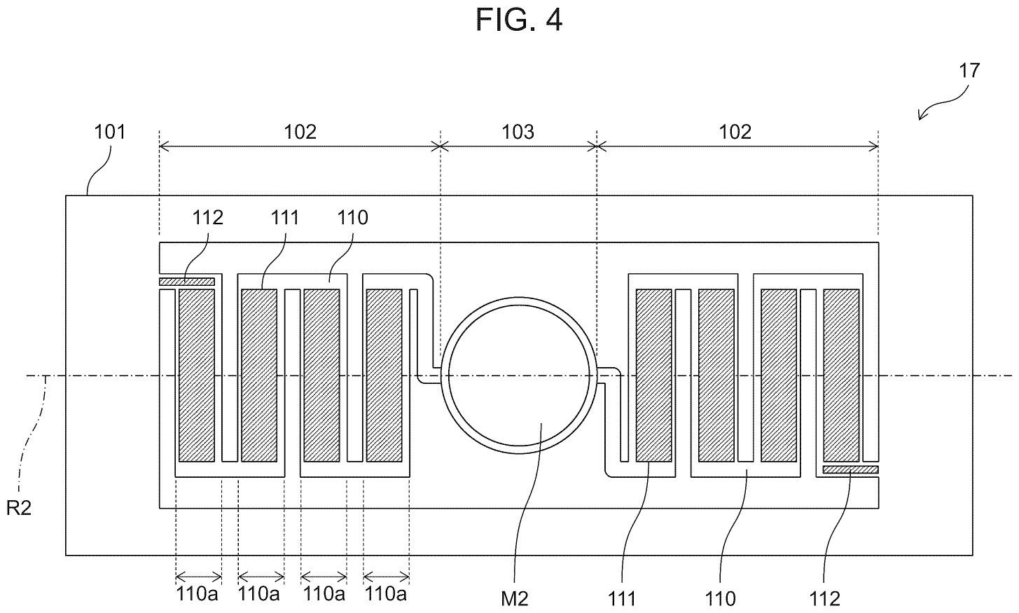

Note that, a configuration of second scanning part 17 will be described later with reference to FIG. 4.

The light reflected by second scanning part 17, that is, the light emitted from projection part 4 is reflected by half mirror 5 and forms frame image 20 in the retina of eye E. That is, the light rays modulated by the video signal (the light rays emitted from light sources 11a to 11c) are scanned in the horizontal direction (X-axis direction) and the vertical direction (Z-axis direction) by first scanning part 15 and second scanning part 17, and thus, frame image 20 for one frame is formed on the retina of eye E.

FIG. 3 is a block diagram illustrating a configuration of a circuit portion of image generation device 3.

Detection part 6 includes light source 61 and imaging element 62, and is connected to controller 41 of projection part 4. Light source 61 is, for example, a light emitting diode (LED) that emits light having an infrared wavelength. Imaging element 62 is, for example, a complementary metal oxide semiconductor (CMOS) image sensor or a charge coupled device (CCD) image sensor. Light source 61 irradiates eyes E of the user with light in accordance with an instruction from controller 41. Imaging element 62 captures an image of eyes E of the user in accordance with an instruction from controller 41, and outputs the captured image to controller 41.

Projection part 4 includes controller 41, first mirror drive circuit 42, second mirror drive circuit 43, laser drive circuit 44, and mirror detection circuit 45.

Controller 41 is an arithmetic processing unit such as a central processing unit (CPU) or a field programmable gate array (FPGA) and a memory. Controller 41 processes a video signal from an external device and controls each part of projection part 4. In addition, controller 41 detects the line of sight of the user by, for example, a dark pupil method, a bright pupil method, a corneal reflex method, or the like based on the captured image from detection part 6. Controller 41 acquires a viewpoint position in frame image 20 formed on the retina of the user based on the detected line of sight of the user.

First mirror drive circuit 42 drives first mirror M1 of first scanning part 15 in accordance with a drive signal from controller 41. Second mirror drive circuit 43 drives second mirror M2 of second scanning part 17 in accordance with a drive signal from controller 41.

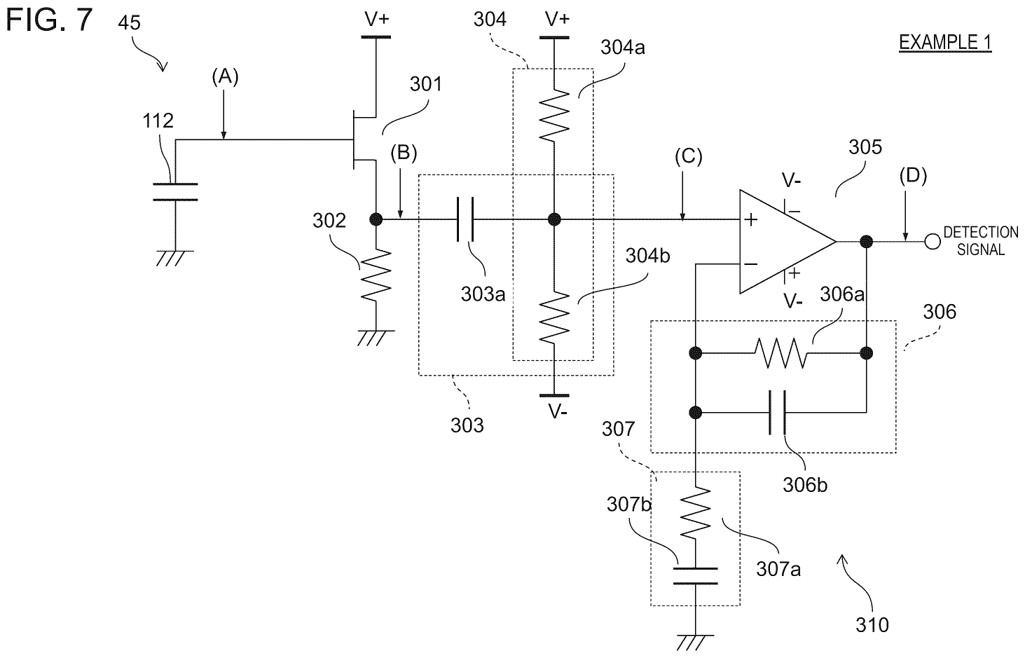

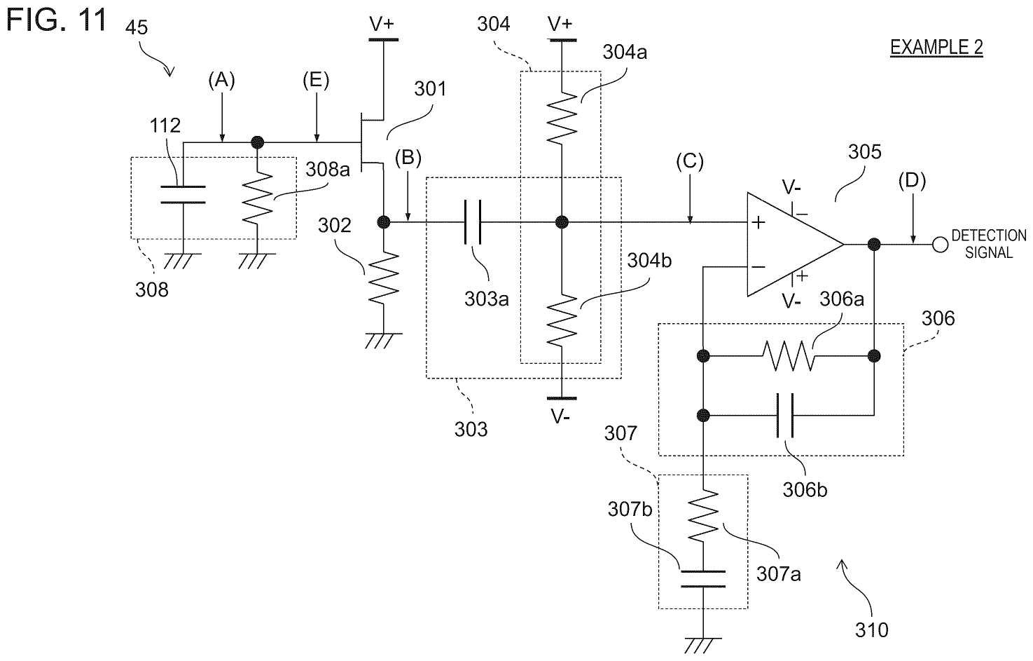

Mirror detection circuit 45 outputs, to controller 41, a detection signal corresponding to a driving state of second mirror M2 in second scanning part 17, that is, a scanning position of the light in the vertical direction (Z-axis direction). A configuration of mirror detection circuit 45 will be described later with reference to FIGS. 7 and 11.

Based on the detection signal from mirror detection circuit 45, controller 41 outputs a drive signal to second mirror drive circuit 43 such that second mirror M2 rotates in the vertical direction (Z-axis direction) with a desired drive waveform. In addition, controller 41 controls second mirror drive circuit 43 such that frame image 20 is drawn at a position of the line of sight based on the line of sight of the user detected by detection part 6 and the detection signal from mirror detection circuit 45.

Note that, image generation device 3 may further include a detection circuit that detects a driving state of first mirror M1 in first scanning part 15, that is, a scanning position of the light in the horizontal direction (X-axis direction). In this case, based on the detection signal from the detection circuit, controller 41 controls first mirror drive circuit 42 such that first mirror MI rotates in the horizontal direction (X-axis direction) with a desired drive waveform.

FIG. 4 is a plan view illustrating a configuration of second scanning part 17.

As illustrated in FIG. 4, in the present exemplary embodiment, second scanning part 17 is a meander type MEMS mirror (light deflecting element). However, second scanning part 17 is not limited to the meander type MEMS mirror, and may be a light deflecting element having another configuration.

Second scanning part 17 includes support 101, a pair of drive parts 102, and movable part 103. Support 101 is a frame-shaped member having a predetermined thickness, and is formed by using, for example, a silicon substrate. In plan view, support 101 has a rectangular outline.

Drive part 102 includes substrate 110 having one end connected to support 101 and the other end connected to movable part 103, and four piezoelectric actuators 111 formed on an upper surface of substrate 110. Substrate 110 has a meander shape meandering in a direction perpendicular to rotation shaft R2. A thickness of substrate 110 is constant. Substrate 110 is formed integrally with support 101 by a material similar to support 101.

Four piezoelectric actuators 111 are arranged on upper surfaces of four regions 110a of substrate 110 extending in the direction perpendicular to rotation shaft R2. Piezoelectric actuator 111 has a configuration in which a piezoelectric body having a constant thickness is sandwiched between an upper electrode and a lower electrode.

The piezoelectric body is made of, for example, lead zirconate titanate (PZT). The upper electrode and the lower electrode are made of, for example, platinum. A voltage (drive signal) is applied between the upper electrode and the lower electrode, and thus, piezoelectric actuator 111 (piezoelectric body) expands or contracts. As a result, substrate 110 is bent, and a driving force for driving movable part 103 is generated.

Movable part 103 is supported by the pair of drive parts 102. Movable part 103 is formed integrally with substrate 110 and support 101 by a material similar to substrate 110 of drive part 102. Movable part 103 has a circular shape in plan view. The shape of movable part 103 may be another shape such as a square. A thickness of movable part 103 is a thickness similar to substrate 110. A rib for suppressing warpage of movable part 103 may be formed on a back surface of movable part 103. Second mirror M2 described above is formed on an upper surface of movable part 103. In a case where the upper surface of movable part 103 has high reflectance, the upper surface of movable part 103 may be second mirror M2.

When drive voltages of the same phase are applied from movable part 103 side to odd-numbered piezoelectric actuators 111, the piezoelectric bodies of piezoelectric actuators 111 are deformed, and odd-numbered substrates 110 (regions 110a) vibrate to be bent. At this time, drive voltages having phases opposite to the drive voltages applied to odd-numbered piezoelectric actuators 111 are applied to even-numbered piezoelectric actuators 111 from movable part 103 side. As a result, the piezoelectric bodies in piezoelectric actuators 111 are deformed, and even-numbered substrate 110 (regions 110a) are deformed to be bent. In doing so, substrates 110 are deformed, and thus, movable part 103 rotates about rotation shaft R2.

Further, on substrate 110 of each drive part 102, a monitoring piezoelectric element 112 is arranged on an upper surface of a portion connected to support 101. Similarly to piezoelectric actuator 111, piezoelectric element 112 has a configuration in which a piezoelectric body is sandwiched between an upper electrode and a lower electrode.

Mirror detection circuit 45 illustrated in FIG. 3 outputs detection signals corresponding to the deformations of two piezoelectric elements 112.

Here, when movable part 103 and second mirror M2 rotate by driving of piezoelectric actuators 111 and piezoelectric elements 112 are deformed accordingly, electric charges corresponding to the deformations are generated in piezoelectric elements 112 due to a piezoelectric effect. As described above, since piezoelectric element 112 has a configuration in which the piezoelectric body having the constant thickness is sandwiched between the upper electrode and the lower electrode, the piezoelectric element 112 is equivalent to a capacitor having a piezoelectric body as a capacitive component. Accordingly, when an electrostatic capacitance of the capacitor is Cd and the amount of electric charges generated in accordance with the deformation is Q, voltage V to be described below is generated in piezoelectric element 112 due to the deformation corresponding to the rotation of second mirror M2.

V=Q/Cd (1)

That is, voltage V is a value corresponding to the deformation of piezoelectric element 112, that is, a value corresponding to the rotation of second mirror M2. In the present exemplary embodiment, the detection signal corresponding to the driving state of second scanning part 17 (light deflecting element) is directly generated in mirror detection circuit 45 from voltage V of Equation (1). This generation will be described later with reference to FIGS. 7 and 11.

Note that, when piezoelectric element 112 is deformed, a current corresponding to the deformation is generated. In general, it is known that the magnitude of the current generated by piezoelectric element 112 is proportional to a speed at which piezoelectric element 112 expands or contracts. That is, the generated current of piezoelectric element 112 is obtained by differentiating an expansion or contraction state of piezoelectric element 112. Accordingly, a detection signal indicating a rotation position of second mirror M2, that is, a scanning position of the light in the vertical direction can also be acquired by integrating the generated current. In the following comparative example, a detection signal is generated by this method.

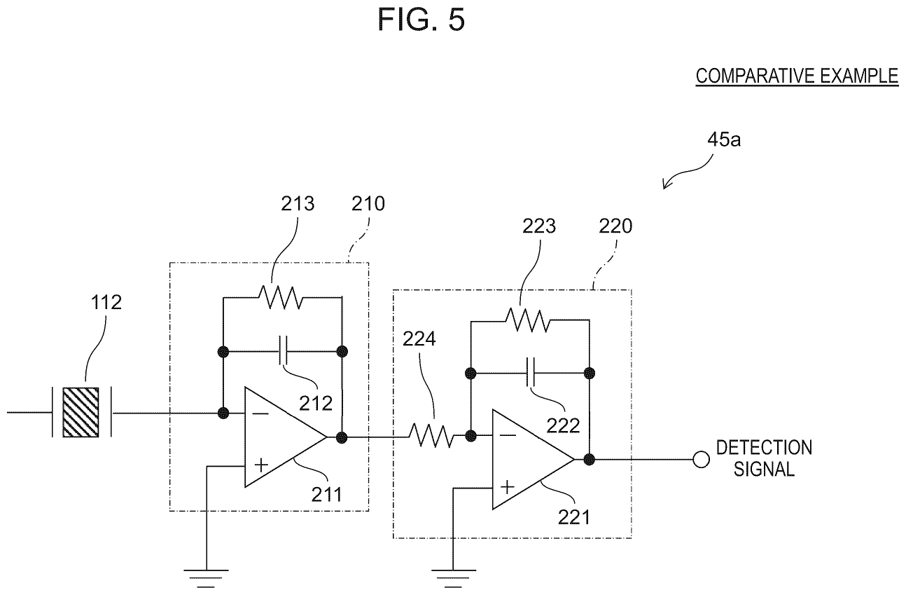

FIG. 5 is a circuit diagram illustrating a configuration of mirror detection circuit 45a according to a comparative example.

Mirror detection circuit 45a according to the comparative example includes current and voltage converter (I/V converter) 210 and integrator 220.

I/V converter 210 includes operational amplifier 211, capacitor 212, and resistor 213. A monitor current of piezoelectric element 112 is input to a negative input terminal of operational amplifier 211. Capacitor 212 and resistor 213 are connected in parallel between the input terminal and an output terminal of operational amplifier 211, and the output of operational amplifier 211 is fed back to the input. As a result, a voltage corresponding to the magnitude of the input monitor current is output from operational amplifier 211.

Integrator 220 includes operational amplifier 221, capacitor 222, and resistors 223 and 224. An output voltage of I/V converter 210 is input to a negative input terminal of operational amplifier 221 via resistor 224. Capacitor 222 and resistor 223 are connected in parallel between the input terminal and an output terminal of operational amplifier 221, and the output of operational amplifier 221 is fed back to the input. Electric charges are accumulated in capacitor 222, and integration is performed. A gain of integrator 220 is determined by two resistors 223 and 224. In doing so, a voltage obtained by integrating the output voltage from I/V converter 210 is output, as the detection signal, from operational amplifier 221.

In the configuration of the comparative example illustrated in FIG. 5, a certain amount of time is required until an integral value of integrator 220 is settled. Thus, as described above, when a drawing position changes with a change in the line of sight of the user, it takes a predetermined time from when the drawing position changes to when the integral value of integrator 220 is settled, and during that time, it is difficult to obtain an appropriate detection signal.

In addition, in the configuration of the comparative example, since integrator 220 is used, in a case where a scanning speed of second scanning part 17 (light polarizing element) changes steeply, it is difficult to generate a high-quality detection signal. That is, integrator 220 cannot follow the change in the scanning speed, and a waveform of the detection signal at this change point hardly becomes a sharp-edge waveform corresponding to the speed change.

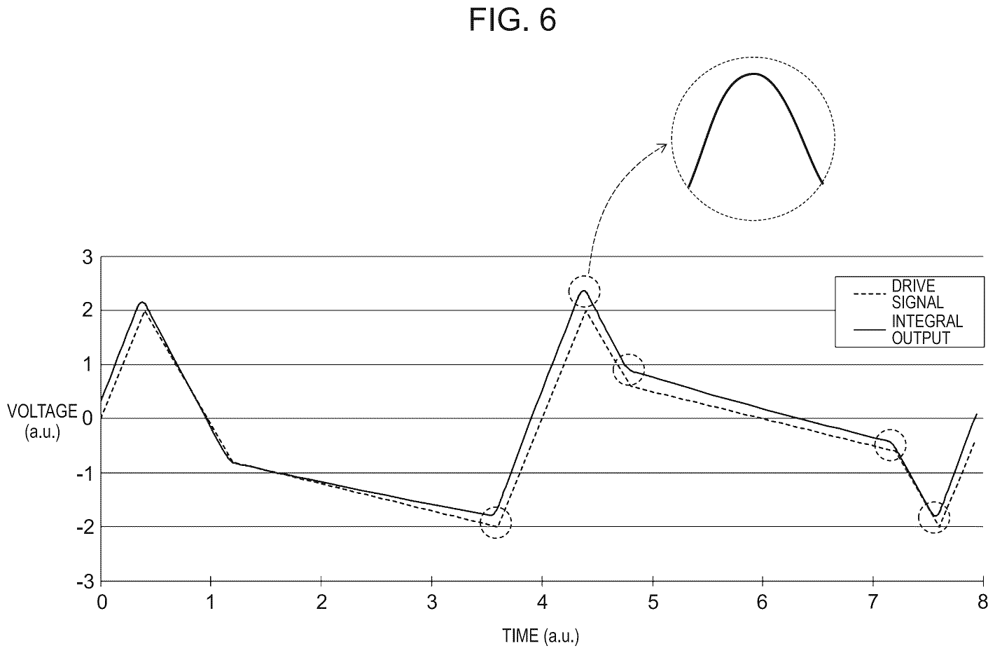

FIG. 6 is a graph representing a simulation result of the detection signal (integral output) output from integrator 220 in the configuration of the comparative example.

FIG. 6 illustrates the detection signal (integral output) output from integrator 220 when piezoelectric actuator 111 is driven by a drive signal indicated by a broken line. As described above, in a case where the drive signal of FIG. 6 is applied to odd-numbered piezoelectric actuators 111, a drive signal having a phase opposite to FIG. 6 is applied to even-numbered piezoelectric actuators 111. FIG. 6 illustrates the detection signal (integral output) based on a current from one piezoelectric element 112. A horizontal axis represents time, and a vertical axis represents voltage. The vertical axis and the horizontal axis are normalized. In addition, a part near a central peak of the detection signal (integral output) is illustrated as an enlarged view in an upper part of the graph.

As illustrated in FIG. 6, the detection signal (integral output) output from integrator 220 is bent at a timing slightly shifted from the drive signal. In addition, the detection signal at a position surrounded by a broken line circle does not have a sharp edge unlike the drive signal near this timing, and has a rounded and smoothly bending shape. As described above, in the configuration of the comparative example, since integrator 220 is used, it is difficult for the waveform of the detection signal at the change point of the scanning speed to accurately reproduce an actual operation state of second scanning part 17 (light deflecting element). Thus, a high-quality detection signal cannot be obtained, and drawing accuracy of the image deteriorates.

Therefore, in the present exemplary embodiment, as described above, the detection signal is generated by directly using the voltage generated in accordance with the deformation of piezoelectric element 112. The configuration thereof will be described below.

### Example 1

FIG. 7 is a circuit diagram illustrating a configuration of mirror detection circuit 45 according to Example 1.

In FIG. 7, V+ represents a positive power supply voltage, and V− represents a negative power supply voltage. An absolute value of V+ and an absolute value of V− are equal to each other. (A) to (D) in FIG. 7 illustrate positions on a circuit.

Mirror detection circuit 45 includes field effect transistor 301 (hereinafter, referred to as “FET 301”), resistor 302, high-pass filter 303, clamp circuit 304, amplifier circuit 305, low-pass filter 306, and high-pass filter 307.

The voltage generated in piezoelectric element 112 is input to a gate of FET 301 having a high impedance. FET 301 constitutes a source follower circuit together with resistor 302. A voltage (source voltage) at position (B) in FIG. 7 changes in accordance with a voltage at position (A), that is, a change in the voltage (monitor voltage) generated in piezoelectric element 112.

High-pass filter 303 includes capacitor 303a and resistor 304b. High-pass filter 303 removes a DC component from the source voltage at position (B). High-pass filter 303 is configured to maintain sensitivity to a voltage in a low frequency band other than the DC component. For example, high-pass filter 303 may have relatively high sensitivity even for a voltage of about several Hz.

Clamp circuit 304 includes two resistors 304a and 304b. Here, one resistor 304b is shared as a resistor for constituting high-pass filter 303.

Clamp circuit 304 sets a reference level (clamp level) to the source voltage from which the DC component is removed by high-pass filter 303. The reference level is determined by a resistance ratio between two resistors 304a and 304b. In configurations of FIG. 7, in a case where the resistance ratio is 1:1, the reference level is 0 V. In a case where the reference level is Vm other than 0 V, clamp circuit 304 offsets the source voltage from which the DC component is removed by high-pass filter 303 by Vm. The reference level is set in accordance with a processing range of a subsequent circuit (for example, an analog digital (AD) converter of controller 41) that processes the detection signal.

Amplifier circuit 305 amplifies a voltage at position (C) adjusted by clamp circuit 304 and outputs the detection signal. Amplifier circuit 305 constitutes a non-inverting amplifier circuit together with resistors 306a and 307a.

Low-pass filter 306 is formed by connecting resistor 306a and capacitor 306b in parallel. As described above, resistor 306a is shared as a resistor on amplifier circuit 305 side. High-pass filter 307 is formed by connecting resistor 307a and capacitor 307b in series. As described above, resistor 307a is shared as a resistor on amplifier circuit 305 side. Low-pass filter 306 and high-pass filter 307 constitute band-pass filter 310 that removes a component in an unnecessary frequency band from the source voltage at position (C). Low-pass filter 306 sets a boundary on a high frequency side of band-pass filter 310, and high-pass filter 307 sets a boundary on a low frequency side of band-pass filter 310.

In the configurations of FIG. 7, a source voltage corresponding to the voltage of piezoelectric element 112 is generated at position (B). At this time, a level shift corresponding to temperature characteristics of FET 301 may occur in the source voltage. High-pass filter 303 removes a DC component corresponding to the level shift from the source voltage and suppresses the level shift. As a result, a source voltage in which the level shift is eliminated is obtained. The source voltage of which a level shift is canceled is subjected to level adjustment by clamp circuit 304. As a result, the source voltage at position (C) is obtained.

Thereafter, the source voltage is amplified and band-limited by amplifier circuit 305 and band-pass filter 310. In doing so, a detection signal at position (D) is obtained. The detection signal is output to controller 41 (see FIG. 3) on a subsequent stage side and processed.

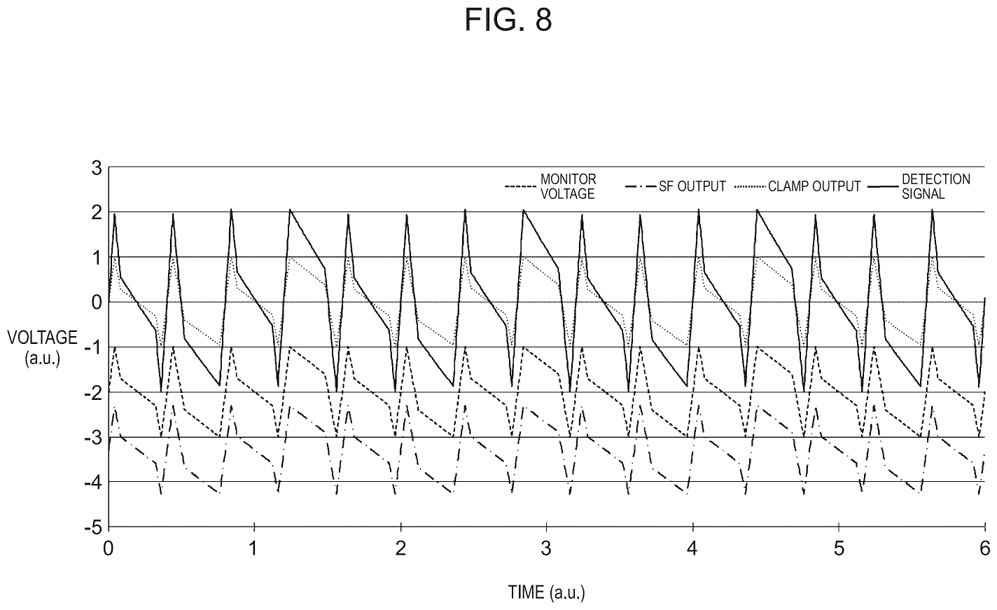

FIG. 8 is a graph representing simulation results of signals (voltages) generated at positions (A) to (D) in FIG. 7.

In this simulation, it is assumed that a drive signal similar to the case of FIG. 6 and a drive signal having an opposite phase to the drive signal are applied to corresponding piezoelectric actuator 111 and second scanning part 17 (light deflecting element) is driven. In addition, it is assumed that a voltage from one of two monitoring piezoelectric elements 112 is input to mirror detection circuit 45 of FIG. 7. In FIG. 8, a horizontal axis represents a time, and a vertical axis represents a voltage. The vertical axis and the horizontal axis are normalized.

A monitor voltage, an SF output (source follower output), a clamp output, and a detection signal in FIG. 8 are voltages at positions (A), (B), (C), and (D) in FIG. 7, respectively. Here, the reference level (clamp level) of clamp circuit 304 is set to 0 V.

As can be seen from FIG. 8, substantially no phase shift occurs in the voltages at positions (A) to (D). In addition, the voltage (SF output) at position (B) is shifted to a negative side with respect to the voltage (monitor voltage) at position (A). However, this shift is eliminated, and the voltage (clamp output) at position (C) fluctuates based on 0 V. This is due to actions of high-pass filter 303 and clamp circuit 304 as described above. The voltage (detection signal) at position (D) is obtained by amplifying the voltage (clamp) at position (C) at a predetermined magnification.

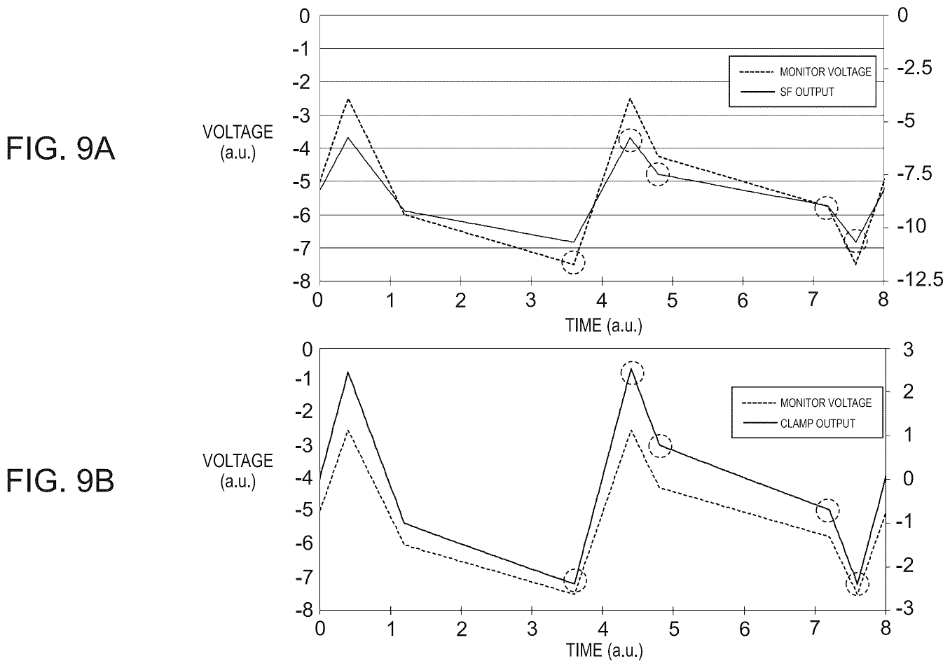

FIG. 9A is a graph in which a voltage (monitor voltage) at position (A) and a voltage (SF output) at position (B) are extracted in a predetermined time range from the simulation results of FIG. 8. A horizontal axis and a vertical axis of the graph are normalized. The vertical axis on a left side is an axis used for the voltage (monitor voltage) at position (A), and the vertical axis on a right side is an axis used for the voltage (SF output) at position (B). The horizontal axis indicates the time range in a normalized manner.

Referring to FIG. 9A, a voltage (SF output) at position (B) surrounded by a broken line circle has a shape-edge waveform similarly to a voltage (monitor voltage) at position (A) at the same timing. From the above description, it can be seen that FET 301 constituting the source follower circuit accurately follows the monitor voltage input to the gate and outputs the SF output (source voltage) corresponding to the monitor voltage.

FIG. 9B is a graph in which a voltage (monitor voltage) at position (A) and a voltage (clamp output) at position (C) are extracted in a predetermined time range from the simulation results of FIG. 8. A time range of an extraction target is the same as the case of FIG. 9A. A horizontal axis and a vertical axis of the graph are normalized. The horizontal axis and the vertical axis on a left side are similar to the case of FIG. 9A. The vertical axis on a right side is an axis used for the voltage (clamp output) at position (C).

Referring to FIG. 9B, the voltage (clamp output) at position (C) surrounded by a broken line circle has a shape-edge waveform similarly to the SF output of FIG. 9A. The voltage (clamp output) at position (C) changes with reference to a base clamp level of 0 V set by clamp circuit 304. From the above description, it can be seen that high-pass filter 303 and clamp circuit 304 immediately behind FET 301 suppress a DC level with respect to the source voltage and set the clamp level while maintaining the followability of the source voltage in FET 301.

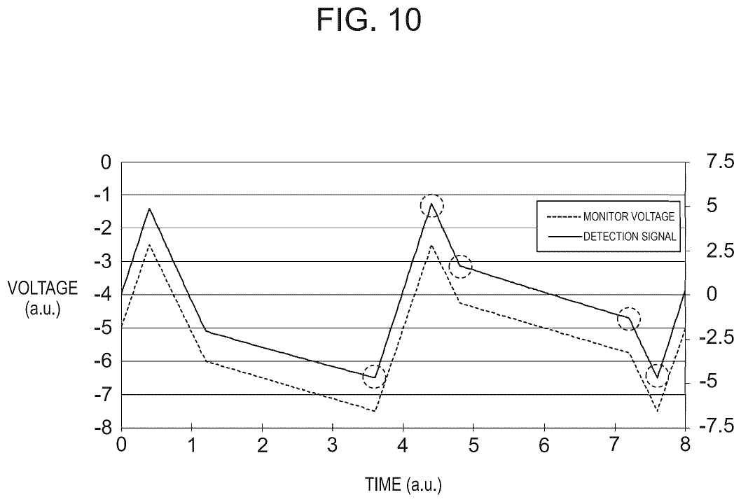

FIG. 10 is a graph in which a voltage (monitor voltage) at position (A) and a voltage (detection signal) at position (D) are extracted in a predetermined time range from the simulation results of FIG. 8. A time range of an extraction target is the same as the case of FIG. 9A. A horizontal axis and a vertical axis of the graph are normalized. The horizontal axis and the vertical axis on a left side are similar to the case of FIG. 9A. The vertical axis on a right side is an axis used for the voltage (detection signal) at position (D).

Referring to FIG. 10, the voltage (detection signal) at position (D) surrounded by a broken line circle has a shape-edge waveform similarly to the SF output of FIG. 9A. In addition, the voltage (detection signal) at position (D) is about twice as large as the clamp output in FIG. 9B. From the above description, it can be seen that amplifier circuit 305 and band-pass filter 310 at a subsequent stage of clamp circuit 304 amplify the source voltage while maintaining the followability of the source voltage in FET 301.

As described above, in accordance with mirror detection circuit 45 of Example 1 illustrated in FIG. 7, it is possible to generate a detection signal that accurately follows the voltage generated in monitoring piezoelectric element 112. Accordingly, even in a case where a scanning speed of second scanning part 17 (light polarizing element) changes steeply, it is possible to generate a detection signal that accurately follows a change in the scanning speed.

### Example 2

FIG. 11 is a diagram illustrating a configuration of mirror detection circuit 45 according to Example 2.

In Example 2, high-pass filter 308 is arranged at a preceding stage of FET 301. Other configurations in Example 2 are similar to the configurations in Example 1 illustrated in FIG. 7.

High-pass filter 308 is formed by arranging resistor 308a in parallel with piezoelectric element 112. Here, a capacitive component based on the piezoelectric body of piezoelectric element 112 constitutes a capacitance of high-pass filter 308. In a case where a DC component is superimposed on the monitor voltage from piezoelectric element 112, high-pass filter 308 removes the DC component from the monitor voltage.

The monitor voltage from piezoelectric element 112 may include a DC component due to characteristics of the piezoelectric body. Thus, this DC component can be superimposed on the monitor voltage in addition to the voltage corresponding to the expansion or contraction of the piezoelectric body. This DC component is based on, for example, a pyroelectric effect of the piezoelectric body. That is, the DC component can be superimposed on the monitor voltage in accordance with an environmental temperature of piezoelectric element 112.

High-pass filter 308 removes the DC component from the monitor voltage. High-pass filter 308 is configured to remove the DC component but maintain sensitivity to the voltage in a low frequency band other than the DC component. For example, high-pass filter 308 may have relatively high sensitivity even for a voltage of about several Hz.

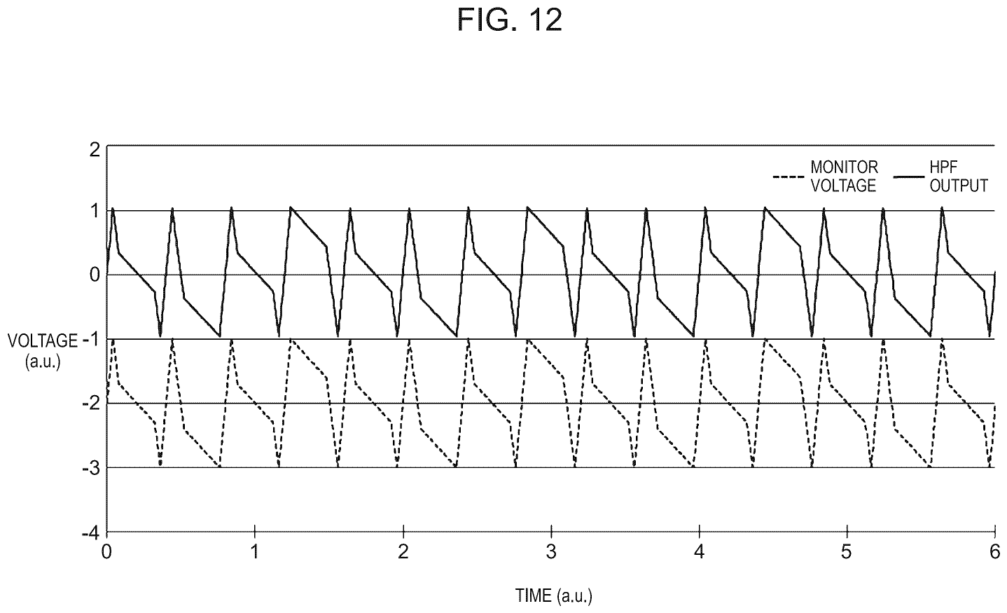

FIG. 12 is a diagram illustrating simulation results related to the output of high-pass filter 308.

In FIG. 12, a horizontal axis represents a time, and a vertical axis represents a voltage. The vertical axis and the horizontal axis are normalized. In FIG. 12, the monitor voltage from piezoelectric element 112, that is, a voltage at position (A) in FIG. 11 is indicated by a broken line. Here, a DC component having a standard value of about −2 V is superimposed on the monitor voltage. This DC component is removed by high-pass filter 308, and a voltage (HPF output) indicated by a solid line is obtained. This voltage corresponds to a voltage at position (E) in FIG. 11.

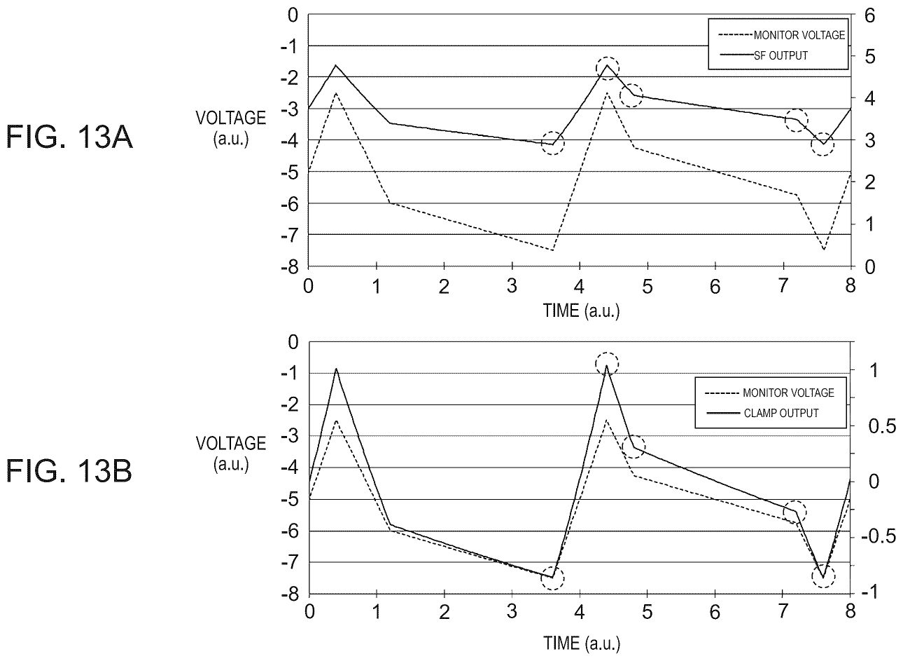

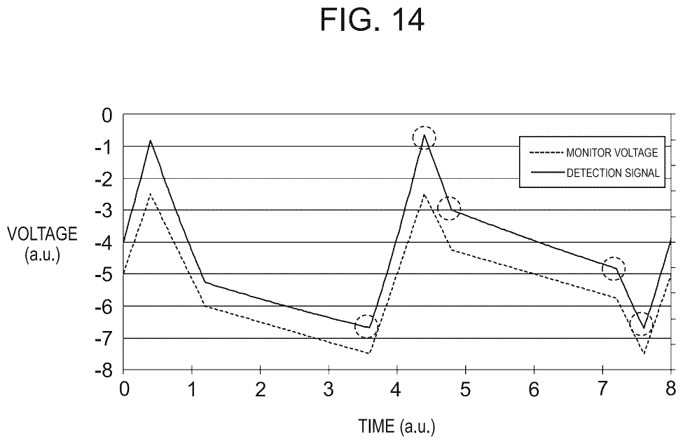

FIGS. 13A to 14 are diagrams illustrating simulation results for the configurations of Example 2 illustrated in FIG. 11. FIG. 13A is a graph representing simulation results of the monitor voltage and the SF output according to Example 2. FIG. 13B is a graph representing simulation results of the monitor voltage and the clamp output according to Example 2. FIG. 14 is a graph representing simulation results of the monitor voltage and the detection signal according to Example 2.

The simulation results of FIGS. 13A to 14 are similar to the simulation results of FIGS. 9A to 10, respectively, except that the HPF output of FIG. 12 is input to the gate of FET 301. The simulation of FIG. 13A corresponds to the simulation of FIG. 9A, the simulation of FIG. 13B corresponds to the simulation of FIG. 9B, and the simulation of FIG. 14 corresponds to the simulation of FIG. 10.

Referring to these simulation results, there is substantially no phase difference between the monitor voltage and the voltage (SF output, CLAMP output, or detection signal) at each position. In addition, the voltage (SF output, CLAMP output, or detection signal) in the portion surrounded by the broken line circle has a shape-edge waveform similar to the case of Example 1. Accordingly, mirror detection circuit 45 of Example 2 illustrated in FIG. 11 can also generate a detection signal that accurately follows the voltage generated in monitoring piezoelectric element 112. Accordingly, even in a case where a scanning speed of second scanning part 17 (light polarizing element) changes steeply, it is possible to generate a detection signal that accurately follows a change in the scanning speed.

In addition, in accordance with the configurations of Example 2, since the DC component of the monitor voltage is removed by high-pass filter 308 arranged at the preceding stage of FET 301, it is possible to generate a high-quality detection signal even though the DC component is superimposed on the monitor voltage by characteristics unique to the piezoelectric body included in piezoelectric element 112, that is, the above-described pyroelectric effect.

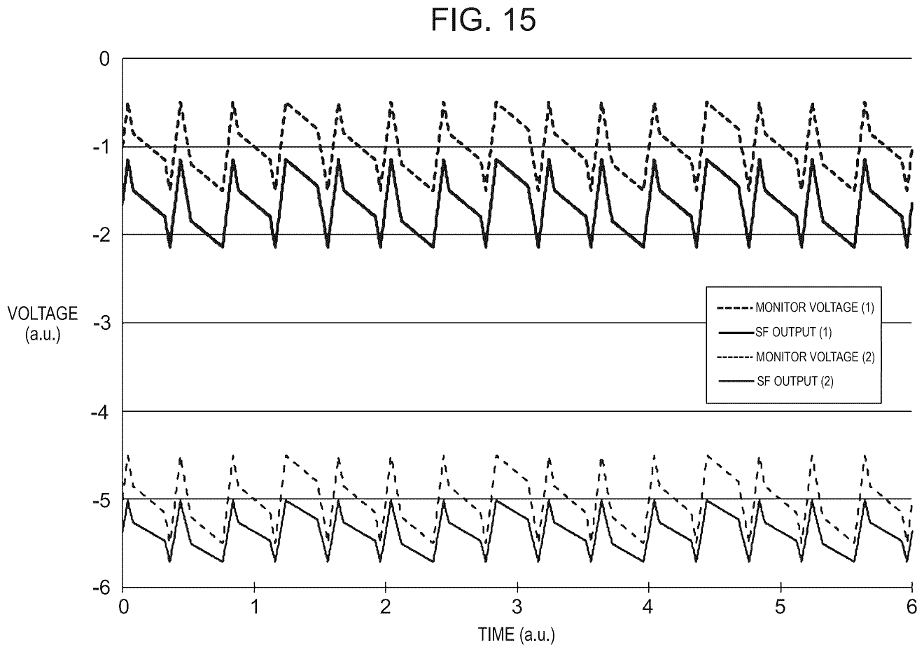

FIG. 15 is a diagram illustrating simulation results of the voltage (source voltage) output from FET 301 (source follower circuit) in a case where two types of monitor voltages (1) and (2) having different DC components are input to the gate of FET 301 in the configurations of Example 1 in which high-pass filter 308 is not arranged.

In FIG. 15, SF output (1) is an output voltage (source voltage) of FET 301 in a case where monitor voltage (1) is input to the gate of FET 301. SF output (2) is an output voltage (source voltage) of FET 301 in a case where monitor voltage (2) is input to the gate of FET 301. Waveforms of monitor voltages (1) and (2) are the same. Monitor voltages (1) and (2) are only different from each other in the superimposed DC component. That is, a DC component larger than monitor voltage (1) in a negative direction is superimposed on monitor voltage (2).

Referring to FIG. 15, SF output (2) is smaller than SF output (1). This is because monitor voltage (2) almost deviates from an input range of FET 301, that is, a voltage range of the input capable of maintaining linearity between the input and the output. When the monitor voltage completely deviates from the input range of FET 301, FET 301 cannot function as the source follower circuit. In this case, a voltage that changes in accordance with the monitor voltage is not output from FET 301.

As described above, in the configurations of Example 1, in a case where a large DC component is superimposed on the monitor voltage from piezoelectric element 112, the source voltage may not be appropriately output from FET 301. By contrast, in the configurations of Example 2, since the DC component is removed from the monitor voltage by high-pass filter 308, even though a large DC component is superimposed on the monitor voltage from piezoelectric element 112, the monitor voltage input to the gate of FET 301 falls within the input range of FET 301 with a margin. Accordingly, even in such a case, a high-quality detection signal can be generated.

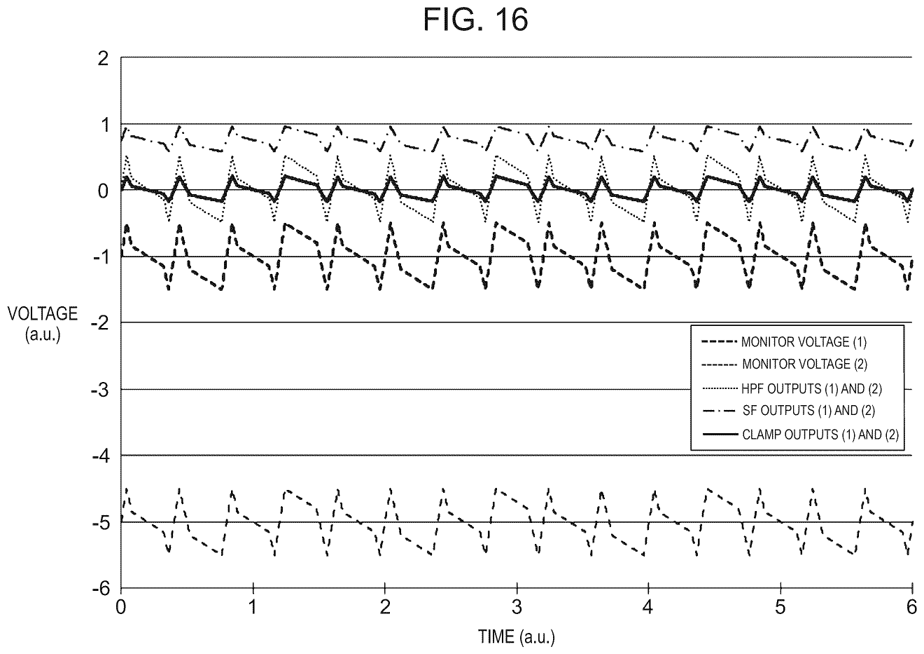

FIG. 16 is a graph representing simulation results of voltages generated at positions (A) to (C) and (E) in FIG. 15 in a case where two types of monitor voltages (1) and (2) illustrated in FIG. 11 are output from piezoelectric element 112.

In these simulation results, waveforms of HPF outputs (1) and (2) overlap each other, waveforms of SF outputs (1) and (2) overlap each other, and waveforms of clamp outputs (1) and (2) overlap each other. Thus, the waveforms overlapping each other are indicated by the same type of lines.

Monitor voltages (1) and (2) are voltages at position (A). HPF outputs (1) and (2) are voltages at position (E). SF outputs (1) and (2) are voltages at position (B). Clamp outputs (1) and (2) are voltages at position (C). Similarly to the case of FIG. 8, since the voltages (detection signal) at position (D) are obtained by amplifying clamp outputs (1) and (2), the voltages are omitted from the simulation results.

Monitor voltages (1) and (2) are both shifted to HPF outputs (1) and (2) based on 0 V. This is because the DC components of monitor voltages (1) and (2) are removed by high-pass filter 308. Thus, the waveforms of HPF outputs (1) and (2) overlap each other as a waveform based on 0 V. SF outputs (1) and (2), which are source follower outputs of HPF outputs (1) and (2), are slightly shifted in a positive direction from a zero level. This is because the DC component is superimposed on SF outputs (1) and (2) due to the temperature characteristics of FET 301.

Note that, SF outputs (1) and (2) have slightly smaller amplitudes than HPF outputs (1) and (2). This is because a gain of the source follower circuit slightly decreases since high-pass filter 308 is arranged in front of FET 301 constituting the source follower circuit.

Clamp outputs (1) and (2), which are voltages at position (C), have waveforms changing based on 0 V. This is because the DC components of SF outputs (1) and (2) are removed by high-pass filter 303 at a subsequent stage of the FET301, and the voltage after the removal of the DC component is clamped based on 0 V by clamp circuit 304.

Thereafter, clamp outputs (1) and (2) are amplified and band-limited by amplifier circuit 305 and band-pass filter 310. As a result, a detection signal included in a target band is generated.

As described above, in accordance with the configurations of Example 2 illustrated in FIG. 11, even in a case where the voltage level of the monitor voltage almost deviates from the input range of FET 301 as in monitor voltage (2) illustrated in FIG. 16, or in a case where the voltage level of the monitor voltage completely deviates from the input range of FET 301, the monitor voltage falls within the input range of FET 301 with a margin by removing the DC component by high-pass filter 308 in the preceding stage of FET 301. Thus, even though a large DC component is superimposed on the monitor voltage due to characteristics unique to piezoelectric element 112, a high-quality detection signal can be generated.

In addition, regardless of the DC component superimposed on the monitor voltage, since the monitor voltage is uniformly corrected to the monitor voltage based on 0 V by high-pass filter 308, the circuit portion (including controller 41) on the subsequent stage side of high-pass filter 308 may be designed without particularly considering the DC component superimposed due to the characteristics unique to piezoelectric element 112. Accordingly, the configuration and processing of the circuit portion of image generation device 3 can be simplified.

Further, in the configuration illustrated in FIG. 11, piezoelectric element 112 is regarded as a capacitor, and thus, high-pass filter 308 is constituted only by adding resistor 308a. Accordingly, the configuration of mirror detection circuit 45 can be simplified.

Finally, gain characteristics and phase characteristics in the configurations of Example 2 will be described.

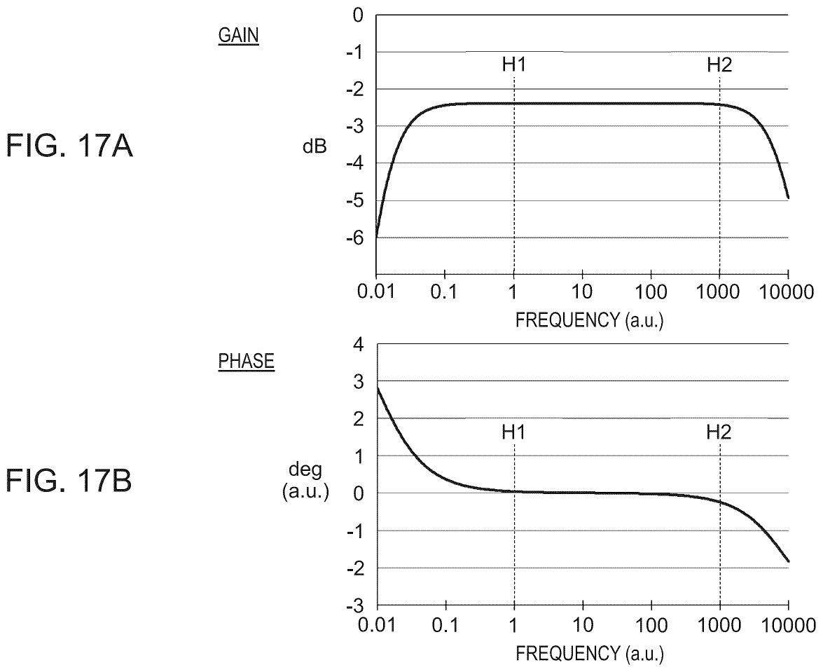

FIG. 17A is a diagram illustrating a graph (Bode diagram) representing gain characteristics of mirror detection circuit 45 according to Example 2. FIG. 17B is a diagram illustrating a graph (Bode diagram) representing phase characteristics of mirror detection circuit 45 of Example 2.

In FIG. 17A, a horizontal axis represents a frequency, and a vertical axis represents a gain (decibel) of the detection signal with respect to the monitor voltage. The horizontal axis in FIG. 17A is a logarithmic axis and is normalized. In FIG. 17B, a horizontal axis represents a frequency, and a vertical axis represents a phase shift (angle) of the detection signal with respect to the monitor voltage. In FIG. 17B, the horizontal axis is a logarithmic axis, and the vertical axis and the horizontal axis are normalized.

As illustrated in FIGS. 17A and 17B, both the gain and the phase of mirror detection circuit 45 are substantially constant in a range of frequencies H1 to H2. Frequency H1 may be defined by high-pass filter 307 of FIG. 11 and frequency H2 may be defined by low-pass filter 306 of FIG. 11. As a result, the detection signal can be stably generated in the range of frequencies H1 to H2.

Note that, FIGS. 17A and 17B illustrate the gain characteristics and the phase characteristics of mirror detection circuit 45 according to Example 2. However, in mirror detection circuit 45 according to Example 1, similar gain characteristics and phase characteristics can be realized by the actions of low-pass filter 306 and high-pass filter 308. As a result, even in the configurations of Example 1, the detection signal can be stably generated in a desired frequency band.

### Effects of Exemplary Embodiment

In accordance with the above-described exemplary embodiment, the following effects are exhibited.

As illustrated in FIGS. 7 and 11, the voltage (monitor voltage) of monitoring piezoelectric element 112 is input to the gate of FET 301 having the high impedance constituting the source follower circuit. The source follower circuit has a wide input range (frequency band) and high followability to the input voltage. Thus, as illustrated in FIGS. 10 and 14, even in a case where a scanning speed of second scanning part 17 (light polarizing element) changes steeply, it is possible to generate a detection signal that accurately follows a change in the scanning speed. Accordingly, the detection signal corresponding to the change in the scanning speed can be accurately generated.

In the configurations of Example 2 illustrated in FIG. 11, resistor 308a connected to the gate of FET 301 is arranged, and high-pass filter 308 is constituted by resistor 308a and the capacitive component of piezoelectric element 112. The voltage generated in piezoelectric element 112 is input to the gate of FET 301 after the DC component is suppressed by high-pass filter 308. As a result, as described with reference to FIGS. 15 and 16, even though the DC component is superimposed on the monitor voltage due to the characteristics unique to piezoelectric element 112, this DC component is suppressed by high-pass filter 308. Thus, the monitor voltage corresponding to the expansion or contraction of piezoelectric element 112 can fall in the input range of FET 301 (source follower circuit) with a margin. Accordingly, a high-quality detection signal can be generated.

As illustrated in FIGS. 7 and 11, mirror detection circuit 45 (detection circuit) includes high-pass filter 303 for suppressing the DC component of the source voltage output from FET 301. As a result, even though the DC component is superimposed on the source voltage due to the temperature characteristics of FET 301, this DC component is suppressed by high-pass filter 303. Accordingly, a high-quality detection signal can be generated.

As illustrated in FIGS. 7 and 11, mirror detection circuit 45 (detection circuit) includes clamp circuit 304 that shifts the source voltage of which a DC component is suppressed by high-pass filter 303 to a predetermined clamp level. As a result, the voltage level of the detection signal can be adjusted to a voltage level suitable for processing of the circuit potion on the subsequent stage side.

As illustrated in FIGS. 7 and 11, clamp circuit 304 includes two resistors 304a and 304b, and one resistor 304b is shared as a resistor of high-pass filter 303. As a result, the configuration of high-pass filter 303 can be simplified, and as a result, the configuration of mirror detection circuit 45 (detection circuit) can be simplified.

As illustrated in FIGS. 7 and 11, mirror detection circuit 45 (detection circuit) includes amplifier circuit 305 for amplifying the source voltage and band-pass filter 310 for removing an unnecessary frequency band component from the source voltage. As a result, a high-quality detection signal can be stably generated in a target frequency band.

As illustrated in FIGS. 7 and 11, band-pass filter 310 is arranged in a feedback line of amplifier circuit 305. As a result, band-pass filter 310 (low-pass filter 306 or high-pass filter 307) can be formed while resistors 306a and 307a on amplifier circuit 305 side are shared. Accordingly, the configuration of mirror detection circuit 45 (detection circuit) can be further simplified.

As illustrated in FIGS. 2 to 4, image generation device 3 includes mirror detection circuit 45 (detection circuit) having the configuration of FIG. 7 or 11, second scanning part 17 (light deflecting element) in which monitoring piezoelectric element 112 is arranged, and controller 41 that controls the operation of second scanning part 17 (light deflecting element) based on the detection signal from mirror detection circuit 45 (detection circuit). In accordance with this configuration, since mirror detection circuit 45 (detection circuit) of FIG. 7 or 11 is provided, the operation state of second scanning part 17 (light deflecting element), that is, the scanning position of the light can be accurately detected. Accordingly, the scanning position of the light can be smoothly and accurately controlled by the detection signal from mirror detection circuit 45 (detection circuit).

### Modification

In the above exemplary embodiment, the configurations of FIGS. 7 and 11 are illustrated as the configuration example of the detection circuit, but the configuration of the detection circuit is not limited thereto. For example, clamp circuit 304 may be omitted, or high-pass filter 303 and band-pass filter 310 may be omitted. The configuration of each circuit potion can also be changed as appropriate. For example, high-pass filter 303 may not share resistor 304b of clamp circuit 304, and a resistor for high-pass filter 303 may be separately arranged. A circuit portion for another purpose may be further arranged in the configurations of FIGS. 7 and 11.

In addition, the waveforms of the monitor voltage and the voltage at each position represented in each simulation are examples for simulation, and the waveform during the actual operation may have another shape.

In addition, in the above exemplary embodiment, as illustrated in FIG. 4, piezoelectric element 112 is arranged at a connecting part of drive part 102 connected to support 101, but the arrangement position of piezoelectric element 112 is not limited thereto. Piezoelectric element 112 may be arranged at a position where the rotation position (scanning position of light) of second mirror M2 can be appropriately detected.

In addition, in the above exemplary embodiment, one of two piezoelectric elements 112 has been described, but similar mirror detection circuit 45 can be applied to another piezoelectric element 112.

In addition, in the above exemplary embodiment, first mirror M1 and second mirror M2 are separately provided, but one mirror that rotates about two axes may be provided instead of first mirror M1 and second mirror M2. In this case, piezoelectric element 112 for mirror position detection may be arranged in the drive part that rotates the mirror in the vertical direction.

In addition, in the above exemplary embodiment, the detection circuit of the present disclosure is used for detecting the scanning position of the light in the vertical direction, but the detection circuit of the present disclosure may be used for detecting the scanning position of the light in the horizontal direction. In this case, piezoelectric element 112 is arranged in first scanning part 15, and the scanning position of the light in the horizontal direction is detected by the detection signal from mirror detection circuit 45.

In addition, in the above exemplary embodiment, an example in which the technology of the present disclosure is applied to image generation device 3 mounted on AR glasses 1 has been described, but the image generation device to which the technology of the present disclosure is applied is not limited thereto. The detection circuit according to the present disclosure can also be used in various devices as long as the voltage output from the piezoelectric element by the piezoelectric effect is used.

The exemplary embodiment of the present disclosure can be modified in various manners as appropriate within the scope of the technical idea recited in the claims.

### Appendix

Technologies below are disclosed by the description of the above exemplary embodiments.

### Technology 1

A detection circuit that detects an operation state of a light deflecting element,
in which the detection circuit
inputs a voltage generated in a monitoring piezoelectric element for monitoring the operation state to a gate of a field effect transistor constituting a source follower circuit, and
generates a detection signal corresponding to expansion or contraction of the piezoelectric element from a source voltage of the field effect transistor.

In accordance with this technology, since the source follower circuit has a wide input range (frequency band) and high followability with respect to the input voltage, it is possible to generate a detection signal that accurately follows a change in a scanning speed even in a case where the scanning speed of the light polarizing element changes sharply. Accordingly, the detection signal corresponding to the change in the scanning speed can be accurately generated.

### Technology 2

The detection circuit according to Technology 1, further including:
a resistor connected to the gate of the field effect transistor, in which a high-pass filter is constituted by the resistor and a capacitive component of the piezoelectric element, and
the voltage generated in the piezoelectric element is input to the gate of the field effect transistor after a DC component is suppressed by the high-pass filter.

In accordance with this technology, even though the DC component is superimposed on the voltage from the piezoelectric element due to characteristics unique to the piezoelectric element, the DC component is suppressed by the high-pass filter. Thus, a voltage corresponding to the expansion or contraction of the piezoelectric element can fall in an input range of the field effect transistor (source follower circuit) with a margin. Accordingly, a high-quality detection signal can be generated.

### Technology 3

The detection circuit according to Technology 1 or 2, further including
a high-pass filter that suppresses a DC component of the source voltage.

In accordance with this technology, even though the DC component is superimposed on the source voltage due to temperature characteristics of the field effect transistor, the DC component is suppressed by the high-pass filter. Accordingly, a high-quality detection signal can be generated.

### Technology 4

The detection circuit according to Technology 3, further including
a clamp circuit that shifts the source voltage of which the DC component is suppressed by the high-pass filter to a predetermined clamp level.

In accordance with this technology, a voltage level of the detection signal can be adjusted to a voltage level suitable for processing of a circuit portion on a subsequent stage side.

### Technology 5

The detection circuit according to Technology 4,
in which the clamp circuit includes two resistors, and
one of the two resistors is shared as a resistor of the high-pass filter.

In accordance with this technology, since the resistor of the clamp circuit is shared by the high-pass filter, the configuration of high-pass filter 303 can be simplified, and as a result, the configuration of the detection circuit can be simplified.

### Technology 6

The detection circuit according to any one of Technologies 1 to 5, further including:
an amplifier circuit that amplifies the source voltage; and
a band-pass filter that removes a component in an unnecessary frequency band from the source voltage.

In accordance with this technology, it is possible to stably generate a high-quality detection signal in a target frequency band.

### Technology 7

The detection circuit according to Technology 6,
in which the band-pass filter is arranged in a feedback line of the amplifier circuit.

In accordance with this technology, it is possible to configure a band-pass filter while sharing a resistor on an amplifier circuit side. Accordingly, the configuration of the detection circuit can be further simplified.

### Technology 8

An image generation device including:
the detection circuit according to any one of Technologies 1 to 7;
the light deflecting element in which the monitoring piezoelectric element is arranged; and
a controller that controls an operation of the light deflecting element based on the detection signal from the detection circuit.

In accordance with this technology, since the image generation device includes the above-described detection circuit, the operation state of the light deflecting element, that is, the scanning position of the light can be accurately detected. Accordingly, the scanning position of the light can be smoothly and accurately controlled by the detection signal from the detection circuit.

The detection circuit and the image generation device of the present disclosure can accurately generate the detection signal corresponding to the change in the scanning speed. Thus, the detection circuit and the image generation device of the present disclosure are useful industrially, particularly in the field of image generation.

What is claimed is:

1. A detection circuit that detects an operation state of a light deflecting element,
wherein the detection circuit
inputs a voltage generated in a piezoelectric element for monitoring the operation state to a gate of a field effect transistor constituting a source follower circuit, and
generates a detection signal corresponding to expansion or contraction of the piezoelectric element from a source voltage of the field effect transistor.

2. The detection circuit according to claim 1, further comprising a resistor connected to the gate of the field effect transistor,
wherein a high-pass filter is constituted by the resistor and a capacitive component of the piezoelectric element, and
the voltage generated in the piezoelectric element is input to the gate of the field effect transistor after a DC component is suppressed by the high-pass filter.

3. The detection circuit according to claim 1, further comprising a high-pass filter that suppresses a DC component of the source voltage.

4. The detection circuit according to claim 3, further comprising a clamp circuit that shifts the source voltage of which the DC component is suppressed by the high-pass filter to a predetermined clamp level.

5. The detection circuit according to claim 4,
wherein the clamp circuit includes two resistors, and
one of the two resistors is shared as a resistor of the high-pass filter.

6. The detection circuit according to claim 1, further comprising:
an amplifier circuit that amplifies the source voltage; and
a band-pass filter that removes a component in an unnecessary frequency band from the source voltage.

7. The detection circuit according to claim 6,
wherein the band-pass filter is arranged in a feedback line of the amplifier circuit.

8. An image generation device comprising:
the detection circuit according to claim 1;
the light deflecting element in which the monitoring piezoelectric element is arranged; and
a controller that controls an operation of the light deflecting element based on the detection signal from the detection circuit.
